(19) United States
(12) Patent Application Publication
(10) Pub. No.: US 2015/0205598 A1
(43) Pub. Date: Jul. 23, 2015

(54) METHOD FOR MANAGING APPLICATION AND ELECTRONIC DEVICE FOR PROCESSING METHOD

(71) Applicant: Samsung Electronics Co., Ltd., Gyeonggi-do (KR)

(72) Inventor: Eun-Hee LIM, Gyeonggi-do (KR)

(73) Assignee: Samsung Electronics Co., Ltd.

(21) Appl. No.: 14/603,719

(22) Filed: Jan. 23, 2015

(30) Foreign Application Priority Data
Jan. 23, 2014 (KR) 10-2014-0008422

(51) Int. Cl. G06F 9/445; G06F 9/44

(52) U.S. Cl. CPC G06F 8/65; G06F 8/71

(57) ABSTRACT

An apparatus and a method for managing an application of an electronic device are provided. A method of operating a first electronic device includes, when an update is detected regarding an application provided to at least one second electronic device, generating an update notice including target information for the application to be updated; transmitting the generated update notice to the second electronic device; and transmitting update data of the application to a second electronic device that has responded to the update notice. A method of operating a second electronic device includes receiving an update notice including target information representing an update object from a first electronic device; determining an application that needs an update operation among already installed applications in the second electronic device based on the target information of the received update notice; and receiving update data from the first electronic device so that the determined application is updated.

### PRIORITY

This application claims priority under 35 U.S.C. §119(a) to a Korean Patent Application filed in the Korean Intellectual Property Office on Jan. 23, 2014 and assigned Serial No. 10-2014-0008422, the entire content of which is incorporated herein by reference.

### BACKGROUND OF THE INVENTION

1. Field of the Invention

The present invention generally relates to an apparatus and a method for managing an application of an electronic device.

2. Description of the Related Art

An electronic device may provide a function using an installation type application. The installation type application is a package file which a user may download via fee payment or for free. The installation type application may include, for example, an APK file for a Google Operating System (OS), an IPA file for an Apple OS, and a CAB file, an EXE file, and the like, for a Microsoft OS.

A provider of the installation type application may improve a function of an already provided application or correct a bug by allowing an electronic device to download and re-install a relevant package file using update data.

FIG. 1 illustrates an application update operation of a general electronic device.

Referring to FIG. 1, a manufacturer of the application (an application server) may transmit an update notice to electronic devices that have downloaded the application.

The update notice may be transmitted in the case where a bug of the application provided to the electronic devices has been corrected or a new function has been added. The electronic device that has received the update notice may or may not perform an application update operation depending on a user's selection.

In FIG. 1, a server 120 having an application of a new version (version 2.0) transmits an update notice 122 informing that an update to the application of the new version is necessary to electronic devices 100 and 110 that use the application of a lower version.

The electronic devices 100 and 110 that accept the update in response to the update notice request the server 120 to transmit data and receive the requested data, and then perform an update operation for the application. The electronic device 110 that uses an application of version 1.5 and the electronic device 100 that uses the application of version 1.0 perform an operation of updating the application using the application of version 2.0.

According to the conventional art, the installation type application provider may allow an already installed application to be updated by informing an electronic device of a user who has downloaded the installation type application that an update is necessary.

Generally, an application update means performing an update operation using recently manufactured specific data (an application of a specific version). A user may or may not accept an update for an already installed application. When an error (for example, a security error, etc.) occurs in an application of a specific version and the application manufacturer requests a user to perform an update operation for not only the application of a version in which the error has occurred but also the application of a version in which the error has not occurred, even a user who has the application of the version in which the error has not occurred may pay unnecessary communication fee or may not be able to use the application while performing the update.

### SUMMARY OF THE INVENTION

The present invention has been made to solve at least the above-mentioned problems and/or disadvantages and to provide at least the advantages described below.

Accordingly, an aspect of the present invention is to provide an apparatus and a method for allowing only an electronic device in which an application corresponding to an update object has been installed to perform an update operation.

In accordance with an aspect of the present invention, a method for operating a first electronic device is provided. The method includes, when an update is detected with respect to an application provided to a second electronic device, generating an update notice including target information for the application to be updated; transmitting the generated update notice to the second electronic device; and transmitting update data of the application to the second electronic device that has responded to the update notice. The target information includes version information of the application that needs an update operation.

In accordance with another aspect of the present invention, a method for operating a second electronic device is provided. The method includes receiving an update notice including target information representing an update object from a first electronic device; determining an application that needs an update operation among already installed applications in the second electronic device based on the target information of the received update notice; and receiving update data from the first electronic device so that the determined application is to be updated.

In accordance with another aspect of the present invention, a first electronic device is provided. The first electronic device includes an update determination module configured to, when an update is detected with respect to an application provided to a second electronic device, generate an update notice including target information for the application to be updated. The first electronic device is configured to transmit the generated update notice to the second electronic device, and to transmit update data of the application to the second electronic device that has responded to the update notice.

In accordance with another aspect of the present invention, a second electronic device is provided. The second electronic device includes a data management module configured to manage update information of an already installed application in the second electronic device; a communication module configured to receive an update notice including target information representing an update object from a first electronic device; and an update determination module configured to determine update necessity of the already installed application based on the update information managed by the data management module and the target information received via the communication module.

In accordance with another aspect of the present invention, a non-transitory computer-readable recording medium is provided. The computer-readable recording medium includes a program recorded thereon in a second electronic device, the program executing operations of receiving an update notice including target information representing an update object from a first electronic device, determining an application that needs an update operation among already installed applications in the second electronic device based on the target information of the received update notice, and receiving update data from the first electronic device so that the determined application is to be updated.

### BRIEF DESCRIPTION OF THE DRAWINGS

The above and other aspects, features and advantages of certain embodiments of the present invention will be more apparent from the following description, taken in conjunction with the accompanying drawings, in which:

FIG. 1 illustrates an application update operation of a general electronic device;

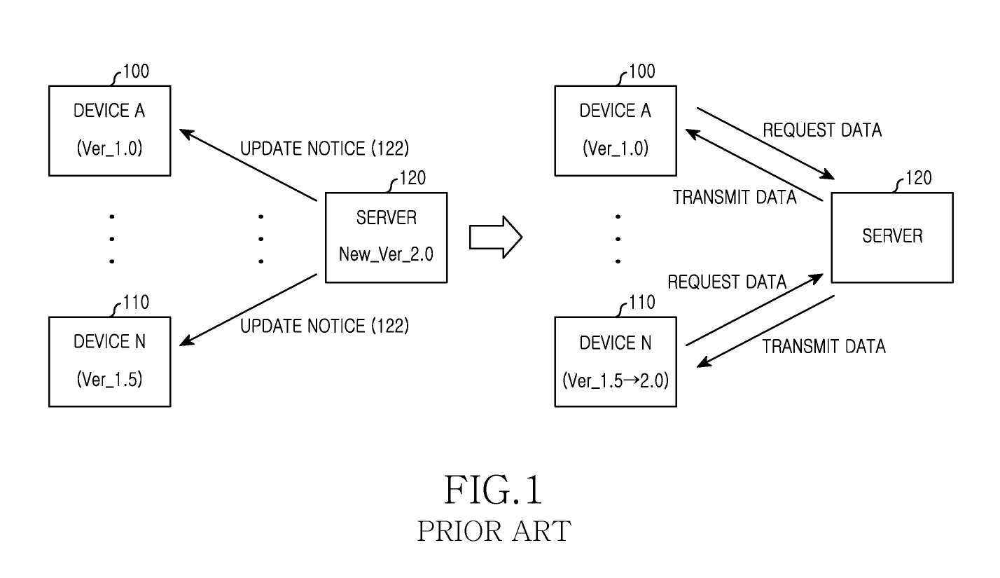

FIG. 2 illustrates an application update operation of an electronic device according to an embodiment of the present invention;

FIG. 3 is a block diagram illustrating a configuration of a network environment including an electronic device according to an embodiment of the present invention;

FIG. 4 is a block diagram illustrating a configuration of an update module according to an embodiment of the present invention;

FIG. 5 is a flowchart illustrating an operation of a first electronic device according to an embodiment of the present invention;

FIG. 6 is a flowchart illustrating an operation of a second electronic device according to an embodiment of the present invention;

FIG. 7 is a flowchart illustrating an operation of a second electronic device according to an embodiment of the present invention;

FIG. 8 is a flowchart illustrating an operation of a first electronic device according to an embodiment of the present invention;

FIG. 9 illustrates a configuration of an update notice according to an embodiment of the present invention;

FIG. 10 is a flow diagram illustrating an application update operation according to an embodiment of the present invention; and

FIG. 11 is a flow diagram illustrating an application update operation according to an embodiment of the present invention.

Throughout the drawings, like reference numerals will be understood to refer to like parts, components, and structures.

### DETAILED DESCRIPTION OF EMBODIMENTS OF THE PRESENT INVENTION

Hereinafter, the present invention is described with reference to the accompanying drawings. The present invention may be changed and have various embodiments, and specific embodiments are described as examples and related detailed descriptions are made in the present specification. However, it should be understood that the various embodiments of the present invention are not limited to a specific embodied form and include all modifications and/or equivalents or substitutions that fall within the spirit and technical scope of the present invention. In the drawing, like reference numerals are used for like elements.

Expressions such as “include”, “may include”, and the like, that may be used in the present disclosure indicate existence of a disclosed relevant function, operation, or element, and the like, and do not limit additional one or more functions, operations, or elements, and the like. Also, it should be understood that terminologies such as “include” or “have”, and the like, in the present disclosure are intended for designating existence of a characteristic, a number, a step, an operation, an element, a part, or a combination thereof in the specification, and do not exclude a possibility of existence or addition of one or more other characteristics, numbers, steps, operations, elements, parts, or a combination thereof

Expressions such as “or”, and the like, in the present disclosure include a certain combination and all combinations of words listed together. For example, “A or B” may include A, include B, or include both A and B.

In the present disclosure, expressions such as “1st”, “2nd”, “first”, “second”, and the like, may modify various elements of the present invention but do not limit the relevant elements. For example, the expressions do not limit the sequence and/or the importance, and the like, of the relevant elements. The expressions may be used for discriminating one element from another element. For example, both a first user apparatus and a second user apparatus are a user apparatus, and represent different user apparatuses. For example, a first element may be named as a second element without departing from the scope of the present invention, and similarly, the second element may be named as the first element.

When it is mentioned that a certain element “is connected to” or “accesses” another element, it should be understood that the element may be directly connected to another element or may directly access another element, but yet another element may exist in the middle. When it is mentioned that a certain element “is directly connected to” or “directly accesses” another element, it should be understood that yet another element does not exist in the middle.

Terminology used in the present disclosure is used for explaining only a specific embodiment and is not intended to limit the present invention. Unless clearly expressed otherwise, expressions of the singular include expressions of the plural.

Unless defined differently, all terminologies used herein including technological or scientific terminologies have the same meaning as that generally understood by a person of ordinary skill in the art to which the present invention belongs. It should be understood that generally used terminologies defined by a dictionary have meanings coinciding with meanings on a context of a related technology, and unless clearly defined in the present disclosure, they are not understood to be an ideal or have excessively formal meaning.

An electronic device according to an embodiment of the present invention may be a device including a communication function. For example, an electronic device may include at least one of a smartphone, a tablet personal computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, or a wearable device (e.g., a head-mounted-device (HMD) such as electronic glasses, an electronic clothing, an electronic bracelet, an electronic necklace, an electronic appcessory, an electronic tattoo, or a smartwatch).

According to an embodiment of the present invention, an electronic device may be a smart home appliance having a communication function. A smart home appliance may include, for example, at least one of a television, a Digital Video Disk (DVD) player, an audio, a refrigerator, an air conditioner, a cleaner, an oven, an electronic range, a washing machine, an air purifier, a set-top box, a TV box (for example, Samsung HomeSync™, Apple TV™, or Google TV™), a video game console, an electronic dictionary, an electronic key, a camcorder, or an electronic frame.

According to an embodiment of the present invention, an electronic device may include at least one of various medical devices (e.g., Magnetic Resonance Angiography (MRA), Magnetic Resonance Imaging (MRI), Computed Tomography (CT), a shooting device, an ultrasonic device, etc.), a navigation device, a Global Positioning System (GPS) receiver, an event data recorder (EDR), a flight data recorder (FDR), an automobile infotainment device, electronic equipment for a ship (ex: a navigation device for a ship, a gyro compass, etc.), an avionics, a security device, or a robot for an industrial use or a home use.

According to an embodiment of the present invention, an electronic device may include at least one of a furniture or a portion of a building/structure including a communication function, an electronic board, an electronic signature receiving device, a projector, or various measurement devices (e.g., waterworks, electricity, gas, or radio wave measuring devices, etc.). An electronic device according to the present invention may be a combination of one or more of the above-described devices. Also, it is obvious to a person of ordinary skill in the art that the electronic device according to the present invention is not limited to the above-described devices.

Hereinafter, an electronic device according to an embodiment of the present invention is described with reference to the accompanying drawings. The term “user” as used in embodiments of the present invention may indicate a person who uses an electronic device or a device (e.g., an artificial intelligence electronic device) that uses the electronic device.

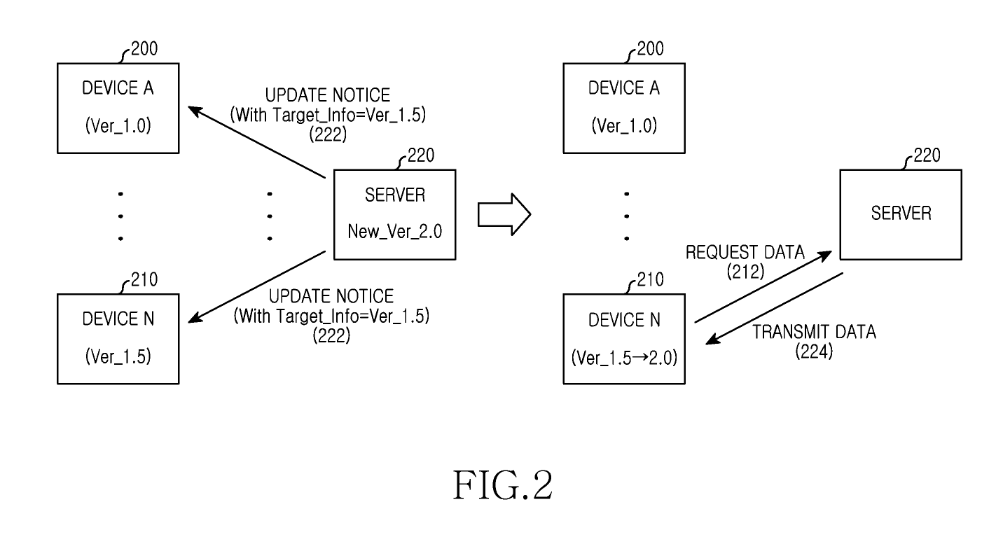

FIG. 2 illustrates an application update operation of an electronic device according to an embodiment of the present invention.

Referring to FIG. 2, an application manufacturer (an application server) may transmit an update notice to electronic devices that have downloaded an application. The update notice may be transmitted when a bug of the application provided to the electronic devices has been corrected or a new function has been added. The electronic device that has received the update notice may or may not perform an application update operation depending on a user's selection. According to an embodiment of the present invention, the update notice may include update object information, for example, target information. The target information may include version information of an application that requires an update operation.

A server 220 in which an application of a new version (version 2.0) exists transmits an update notice 222 informing update is necessary for the application of the new version to electronic devices 200 and 210 that use the application of lower version. Here, the update notice specifies that the application of version 1.5 is the one should be updated to the application of version 2.0. That is, the update notice includes target information, which specifies the update object that requires an update. Here, the update object is a device using the application of version 1.5.

The electronic device that has received the update notice determines whether an application of the electronic device is an update object using the target information included in the update notice. Here, the electronic device A 200 in which an application of version 1.0 has been installed determines that the electronic device A 200 is not an update object, and the electronic device N 210 in which an application of version 1.5 has been installed determines that the electronic device N 210 is an update object.

According to an embodiment of the present invention, when it is determined that an application of the electronic device N 210 is an update object, the electronic device N 210 may request the application server 220 to transmit update data 212. According to another embodiment of the present invention, when it is determined that an application of the electronic device N 210 is an update object, the electronic device N 210 may provide information informing an update of the application is necessary and then request the application server 220 to transmit update data 212 when detecting a user's input.

The electronic device N 210 that has requested update data in response to the update notice receives data 224 regarding the request from the server 220, and then performs an update operation of the application.

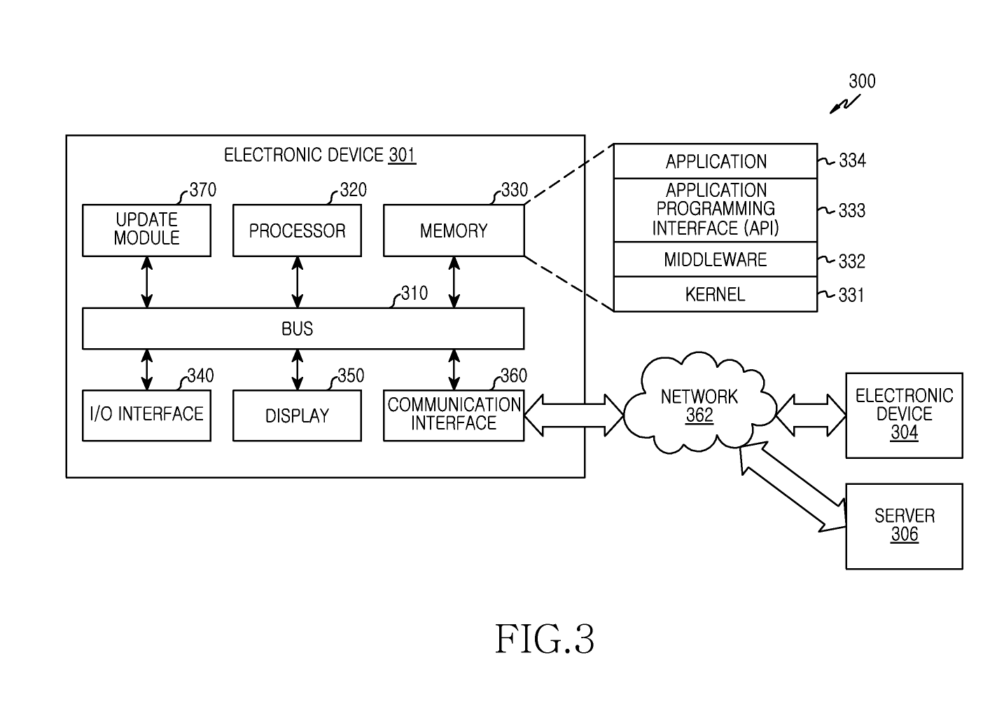

FIG. 3 is a block diagram illustrating a configuration of a network environment 300 including an electronic device 301 according to an embodiment of the present invention. Referring to FIG. 3, the electronic device 301 includes a bus 310, a processor 320, a memory 330, an input/output (I/O) interface 340, a display 350, and a communication interface 360, and an update module 370.

The bus 310 is a circuit for connecting the above-described elements with each other, and transferring communication information (e.g., a control message) between the above-described elements.

The processor 320 receives, for example, an instruction from the above-described other elements (e.g., the memory 330, the I/O interface 340, the display 350, the communication interface 360, or the update module 370, etc.) via the bus 310, deciphers the received instruction, and executes an operation or a data process corresponding to the deciphered instruction.

The memory 330 stores an instruction or data received from the processor 320 or other elements (e.g., the I/O interface 340, the display 350, the communication interface 360, or the update module 370, etc.), or generated by the processor 320 or other elements. The memory 330 may include, for example, programming modules such as a kernel 331, a middleware 332, an application programming interface (API) 333, or an application 334. Each of the programming modules may be configured using software, firmware, hardware, or a combination of two or more of these.

The kernel 331 controls or manages system resources (e.g., the bus 310, the processor 320, or the memory 330, or the update module 370, etc.) used for executing an operation or a function implemented in the rest of the programming modules, for example, the middleware 332, the API 333, or the application 334. Also, the kernel 331 provides an interface for allowing the middleware 332, the API 333, or the application 334 to access an individual element of the electronic device 301 and controls or manages the same.

The middleware 332 performs a mediation role so that the API 333 or the application 334 may communicate with the kernel 331 to give and take data. Also, in connection with task requests received from the applications 334, the middleware 332 performs a control (e.g., scheduling or load balancing) for a task request using, for example, a method of assigning priority for using a system resource (e.g., the bus 310, the processor 320, or the memory 330, or the update module 370, etc.) of the electronic device 301 to at least one of the applications 334.

The API 333 is an interface for allowing the application 334 to control a function provided by the kernel 331 or the middleware 332, and may include at least one interface or function (e.g., an instruction) for file control, window control, image processing, or character control, etc.

According to an embodiment of the present invention, the application 334 may include a Short Messaging Service/Multimedia Messaging Service (SMS/MMS) application, an e-mail application, a calendar application, an alarm application, a health care application (e.g., an application for measuring quantity of motion or blood sugar, etc.), or an environment information application (e.g., an application providing atmospheric pressure, humidity or temperature information, etc.). Alternatively, the application 334 may be an application related to information exchange between the electronic device 301 and an external electronic device (e.g., the electronic device 304). The application related to the information exchange may include, for example, a notification relay application for transferring specific information to the external electronic device or a device management application for managing the external electronic device.

For example, the notification relay application may include a function for transferring notification information generated from a different application (e.g., an SMS/MMS application, an e-mail application, a health care application, or an environment information application) of the electronic device 301 to an external electronic device (e.g., the electronic device 304). Alternatively, the notification relay application may, for example, receive notification information from an external electronic device (e.g., the electronic device 304) and provide the same to a user. The device management application may manage (e.g., install, delete, or update) a function (e.g., turn-on/turn-off of an external electronic device itself (or some constituent parts) or luminance (or resolution) control of a display) of an external electronic device (e.g., the electronic device 304) communicating with the electronic device 301 and an application operating in the external electronic device or a service (e.g., a communication service or a message service) provided by the external electronic device.

According to an embodiment of the present invention, the application 334 may include a designated application depending on an attribute (e.g., a kind of an electronic device) of the external electronic device (e.g., the electronic device 304). For example, when the external electronic device is an MP3 player, the application 334 may include an application related to music reproduction. Similarly, when the external electronic device is a mobile medical health care device, the application 334 may include an application related to health care. According to an embodiment of the present invention, the application 334 may include at least one of an application designated in the electronic device 301 and an application received from the external electronic device (e.g., the server 306 or the electronic device 304).

The I/O interface 340 transfers an instruction or data input from a user via an I/O unit (e.g., a sensor, a keyboard, or a touchscreen) to the processor 320, the memory 330, the communication interface 360, or the update module 370 via the bus 310, for example. For example, the I/O interface 340 provides data regarding a user's touch input via the touchscreen to the processor 320. Also, the I/O interface 340, for example, outputs an instruction or data received via the bus 310 from the processor 320, the memory 330, and the communication interface 360, or the update module 370 via the I/O unit (e.g., a speaker or a display). For example, the I/O interface 340 outputs voice data processed by the processor 320 to a user via a speaker.

The display 350 displays various information (e.g., multimedia data or text data, etc.) to a user.

The communication interface 360 connects the electronic device 301 with an external device (e.g., the electronic device 304 or the server 306) for communication. For example, the communication interface 360 may be connected with a network 362 via wireless communication or wired communication to communicate with the external device. The wireless communication may, for example, include at least one of Wireless Fidelity (Wi-Fi), Bluetooth (BT), Near Field Communication (NFC), Global Positioning System (GPS), or cellular communication (e.g., Long Term Evolution (LTE), LTE Advanced (LTE-A), Code Division Multiple Access (CDMA), Wideband CDMA (WCDMA), Universal Mobile Telecommunications System (UMTS), Wireless Broadband (WiBro), or Global System for Mobile communication (GSM), etc.). The wired communication may include, for example, at least one of Universal Serial Bus (USB), High Definition Multimedia Interface (HDMI), recommended standard 232 (RS-232), and plain old telephone service (POTS).

According to an embodiment of the present invention, the network 362 may be a telecommunications network. The telecommunications network may include at least one of a computer network, the Internet, an Internet of things, and a telephone network. According to an embodiment, a protocol (e.g., a transport layer protocol, a data link layer protocol, or a physical layer protocol) for communication between the electronic device 301 and an external device may be supported by at least one of the application 334, the application programming interface 333, the middleware 332, the kernel 331, or the communication interface 360.

According to an embodiment of the present invention, the update module 370 communicates with the external electronic device 304 or the server 306 using the communication interface 360. For example, the update module 370 receives an installation type application from the external electronic device 304 or the server 306 to install the same in a storage space of the electronic device. According to an embodiment of the present invention, the update module 370 performs an update operation for an already installed application. According to an embodiment of the present invention, the update module 370 determines whether to perform an update operation for an already installed application based on target information included in an update notice received from the external electronic device 304 or the server 306 that has provided the installation type application. According to an embodiment of the present invention, the update notice includes target information representing version information of an application that requires an update operation. When version information of an already installed application is included in the target information of the update notice, the update module 370 determines the already installed application is an update object and performs an update operation for the application.

According to another embodiment of the present invention, the update module 370 transmits version information of the already installed application to the external electronic device 304 or the server 306 that has provided the installation type application to determine whether an application that needs updating exists. When the version information transmitted by the update module 370 corresponds to an update object, the external electronic device 304 or the server 306 provides update data to the electronic device 301.

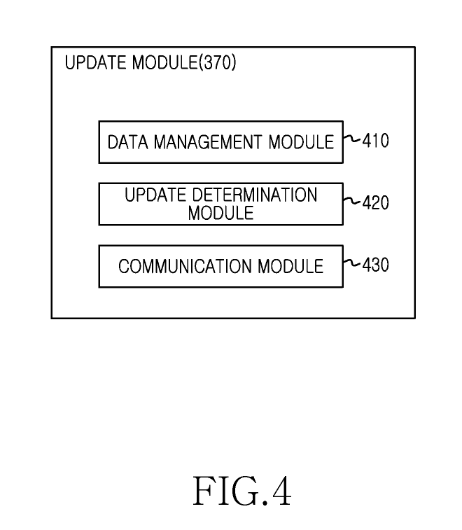

FIG. 4 is a block diagram illustrating a configuration of an update module 307 according to an embodiment of the present invention. Referring to FIG. 4, the update module 370 includes a data management module 410, an update determination module 420, and a communication module 430.

The data management module 410 manages data stored in the electronic device. According to an embodiment of the present invention, the data management module 410 installs, removes, or changes an application using the installation type application. The changing of the application may replace an already installed application with an application of which a bug has been corrected or to which a function has added using update data.

The data management module 410 manages update information of an application installed in the electronic device. According to an embodiment of the present invention, the data management module 410 manages a latest updated date for the application, information (for example, version information, etc.) for a latest updated file, an update history for an application, and the like.

The update determination module 420 determines an application corresponding to an update object among applications installed in the electronic device.

The update determination module 420 analyzes an application update notice (an update request) provided from an application provider to determine an application as an update object. The application update notice may include information of an update version and a target update version. The update version may be a version of an application after an update is performed, and the target update version may be a version of an application on which an update is to be performed.

When receiving an update request for an application, the update determination module 420 determines the application is an update object only if the version (current version) of the already installed application is the same as the version included in the information of the target update version (target information) received from a service provider.

When an update object is determined by the update determination module 420, the communication module 430 requests update data for the relevant application.

According to another embodiment of the present invention, the communication module 430 provides information (version information) for an already installed application to the server that provides the application and determines whether an updatable application exists.

According to yet another embodiment of the present invention, when the update module 370 provides a function (a server function) that provides an application, the communication module 430 requests electronic devices that have downloaded an installation type application to update the application. The communication module 430 provides information of a version (target information) of an application corresponding to an object on which an update is to be performed to the electronic device.

Hereinafter, a first electronic device is an electronic device (for example, an application server) that has provided data (for example, an installation type application) to a second electronic device, and the second electronic device is an electronic device (for example, a smartphone) that has received/downloaded data (for example, an installation type application) provided from the first electronic device and has stored or installed the data.

According to an embodiment of the present invention, when an update for an application already provided to a second electronic device is detected, a first electronic device includes an update determination module for generating an update notice including target information for the application to be updated. The first electronic device may be configured to transmit the generated update notice to a second electronic device, and to transmit update data of the application to the second electronic device that has responded to the update notice.

According to an embodiment of the present invention, the first electronic device may include the update determination module for receiving information for an already installed application in the second electronic device from the second electronic device, determining the application that needs an update operation among applications installed in the second electronic device based on the received information, and generating the update notice including information for the determined application.

According to an embodiment of the present invention, the first electronic device may include an application server.

According to an embodiment of the present invention, the second electronic device may include a data management module for managing update information of an already installed application in the second electronic device, a communication module for receiving an update notice including target information representing an update object from the first electronic device, and an update determination module for determining update necessity for an already installed application based on update information managed by the data management module and target information received via the communication module.

According to an embodiment of the present invention, the data management module may be configured to manage at least one of a latest updated date for the already installed application, version information of a latest updated file for the already installed application, an update history for the already installed application as the update information.

According to an embodiment of the present invention, when it is determined, by the update determination module, that the update information corresponds to the target information, the communication module may be configured to request the first electronic device to transmit update data for the already installed application corresponding to the update information.

According to an embodiment of the present invention, the second electronic device may include a mobile communication terminal.

According to an embodiment of the present invention, the second electronic device may be configured to include the communication module for transmitting the update information of the already installed application to a first electronic device, receiving information of an application determined by the first electronic device that needs updating from the first electronic device, and requesting update data for the already installed application based on the received information.

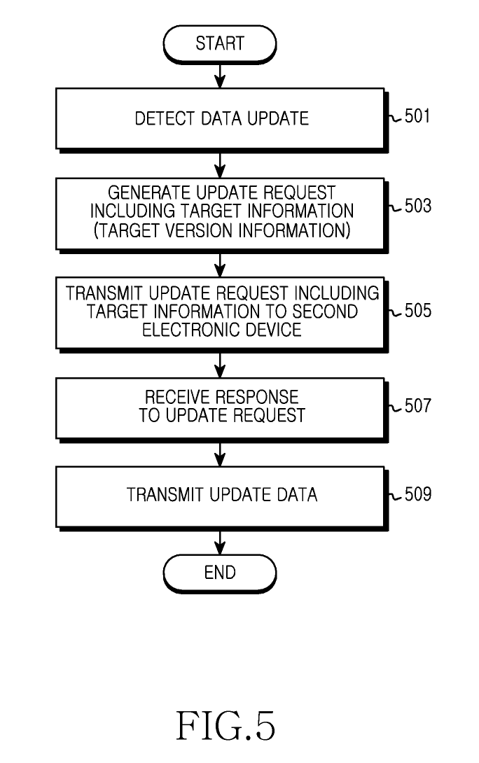

FIG. 5 is a flowchart illustrating an operation of a first electronic device according to an embodiment of the present invention.

Referring to FIG. 5, the first electronic device may determine whether a data update is detected in step 501. Here, the data update is a correction of a bug of an application or an addition of a function of an application.

The first electronic device generates an update notice (an update request) including target information that specifies a target, i.e., data (an application of a specific version) on which an update is to be performed in step 503. According to an embodiment of the present invention, the target information may include version information of an application of which a bug has been corrected or a function has been added. According to an embodiment of the present invention, the target information may include at least one target.

According to an embodiment of the present invention, the first electronic device may limit a usage of an application of a specific version using the update notice. For example, the first electronic device may force an application of a specific version, which is the target included in the target information in the update notice, to perform an update operation.

The first electronic device transmits an update notice (an update request) including the target information to the second electronic device in step 505.

The first electronic device receives a response to the update request in step 507, and transmits the update data (an application of a new version) to the second electronic device in response to the response in step 509. The update data may be data for correcting a bug of an application provided to the second electronic device or adding a function of an application provided to the second electronic device.

According to an embodiment of the present invention, the first electronic device may further receive an update request from the second electronic device that has stored updatable data (an application of a specific version), which is the target included in the target information.

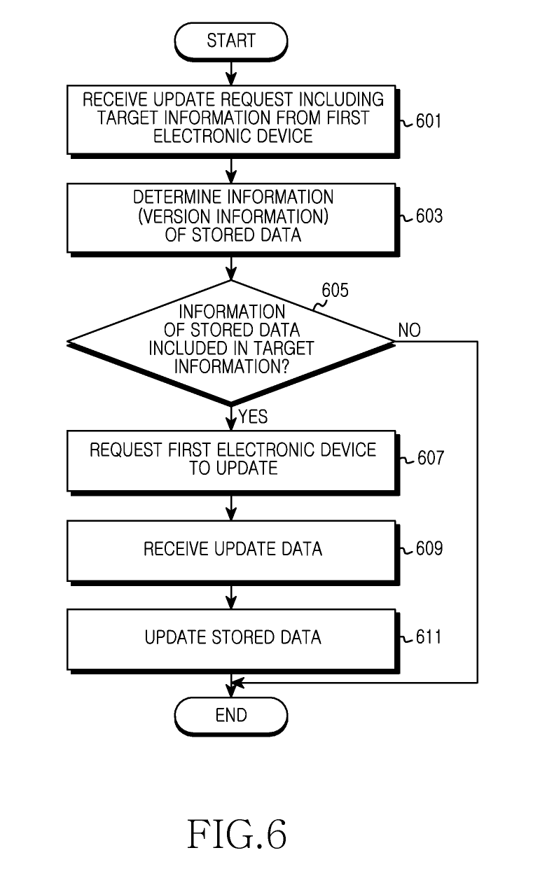

FIG. 6 is a flowchart illustrating an operation of a second electronic device according to an embodiment of the present invention.

Referring to FIG. 6, the second electronic device determines whether an update request including target information is received from a first electronic device in step 601. According to an embodiment of the present invention, the update request is a request requesting an already installed application to add a function or correct a bug, and the target information may include version information of an application of which a bug is corrected or whose function is added.

The second electronic device determines version information of stored data (for example, an already installed application) in step 603, and determines whether the version information of the stored data is the same as the version information included in the target information in step 605.

When it is determined that the version information of the stored data is not included in the target information, the second electronic device determines an update operation for the application is not necessary. According to an embodiment of the present invention, when the version information of the stored data is not included in the target information, the second electronic device may ignore the received update request.

When the version information of the stored data is the same as the version information included in the target information, the second electronic device determines that an update operation for the stored data is necessary, and requests the first electronic device to update in step 607. According to an embodiment of the present invention, when an update operation for stored data is necessary, the second electronic device may automatically request update data, or may detect a user's input and then request update data.

The second electronic device receives the update data from the first electronic device in order to update (correcting a bug or adding a function of an already installed application) the stored data in step 609, and then performs an operation of updating the already stored data using the received update data in step 611.

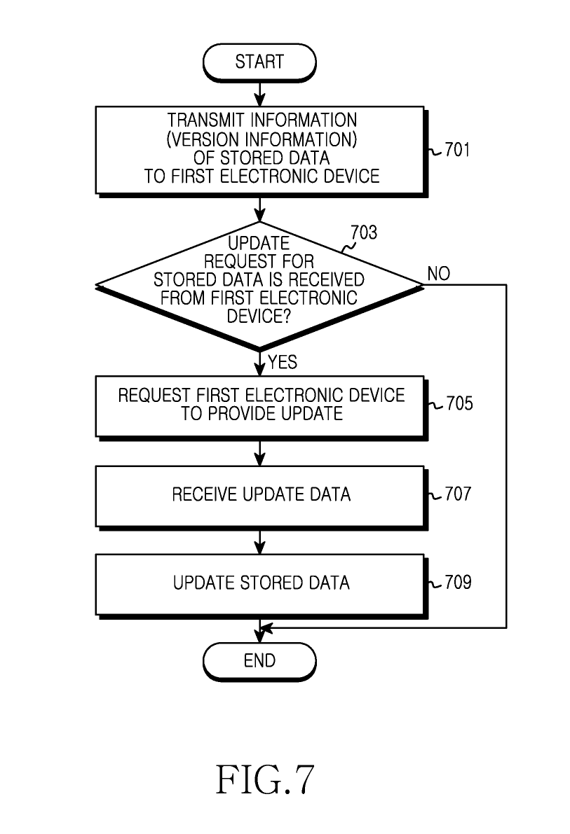

FIG. 7 is a flowchart illustrating an operation of a second electronic device according to an embodiment of the present invention.

According to an embodiment of the present invention, the second electronic device may transmit version information of already stored data (the installed application) to the first electronic device (a server) to determine whether an updatable application exists.

Referring to FIG. 7, the second electronic device transmits information of the already stored data to the first electronic device in step 701.

The second electronic device determines whether an update request for the already stored data is received from the first electronic device in step 703.

When it is determined that the second electronic device does not receive the update request from the first electronic device, the second electronic device determines an update operation for the application is not necessary.

When it is determined that the second electronic device receives the update request from the first electronic device, the second electronic device requests the first electronic device to provide an update in step 705. The second electronic device may request the update data with respect to the already stored data (for example, an application that needs updating) that needs updating.

The second electronic device receives the update data in step 707, and then performs an update operation for the already stored data using the received update data in step 709.

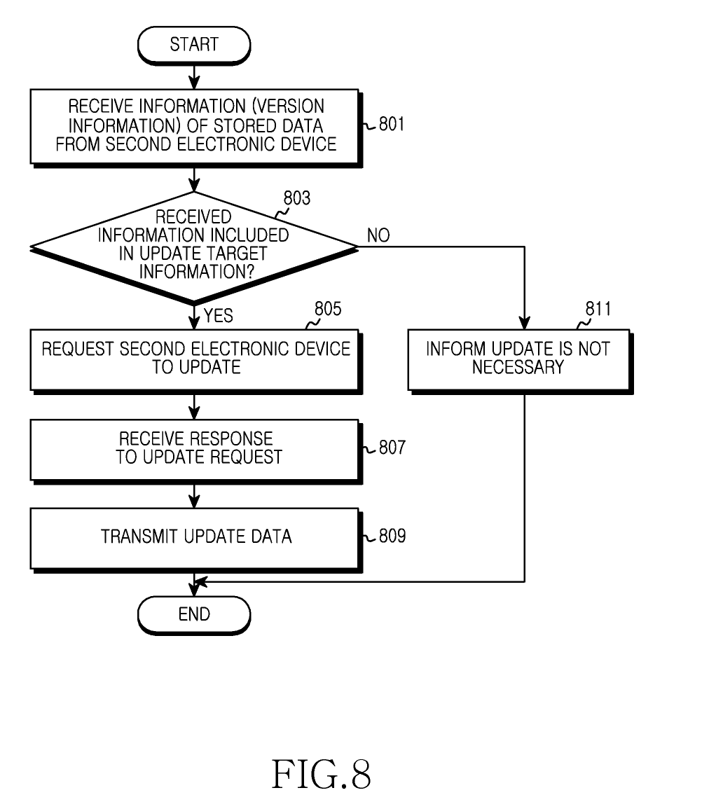

FIG. 8 is a flowchart illustrating an operation of a first electronic device according to an embodiment of the present invention.

Referring to FIG. 8, the first electronic device receives information (version information) of stored data (update object data) from the second electronic device in step 801.

The first electronic device determines whether the received information of data is the same as the information of data included in update target information in step 803. Here, the update target information may be information for updated data among data in the first electronic device. According to an embodiment of the present invention, the update target information may be a list of applications that need updating among applications provided to the second electronic device. According to an embodiment of the present invention, the first electronic device may determine whether version information of an application received from the second electronic device is the same as the version information included in the already stored update target information.

When it is determined that the received information of data is not included in the update target information, the first electronic device informs the second electronic device that an update is not necessary in step 811.

When it is determined that the received information of data is the same as the information of data included in the update target information, the first electronic device requests the second electronic device to perform an update in step 805.

The first electronic device receives a response to an update request in step 807, and transmits the update data to the second electronic device in response to the response in step 809.

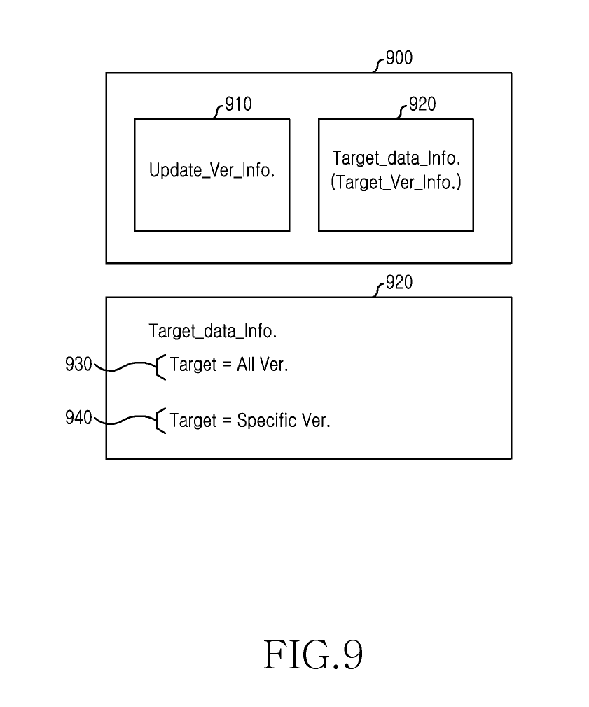

FIG. 9 illustrates a configuration of an update notice according to an embodiment of the present invention.

Referring to FIG. 9, the update notice 900 includes update version information 910 and target data information 920 (for example, target information) which is information representing an update object. The update version information 910 is information of a version of an application after an update has been performed (e.g., a latest version of the application), and the target data information 920 may be information of a version corresponding to an object on which an update is to be performed (e.g., an old version of the application). For example, the target data information 920 may be version information of an application that needs an update operation.

The update notice 900 requests an update with respect to at least one target included in the target data information. According to an embodiment of the present invention, the update notice 900 requests an update of all versions 930 of the application (i.e., any version of the application that is installed in the electronic device will be updated), or requests an update of a specific version 940 of the application (i.e., only a specific version of the application that is installed in the electronic device will be updated).

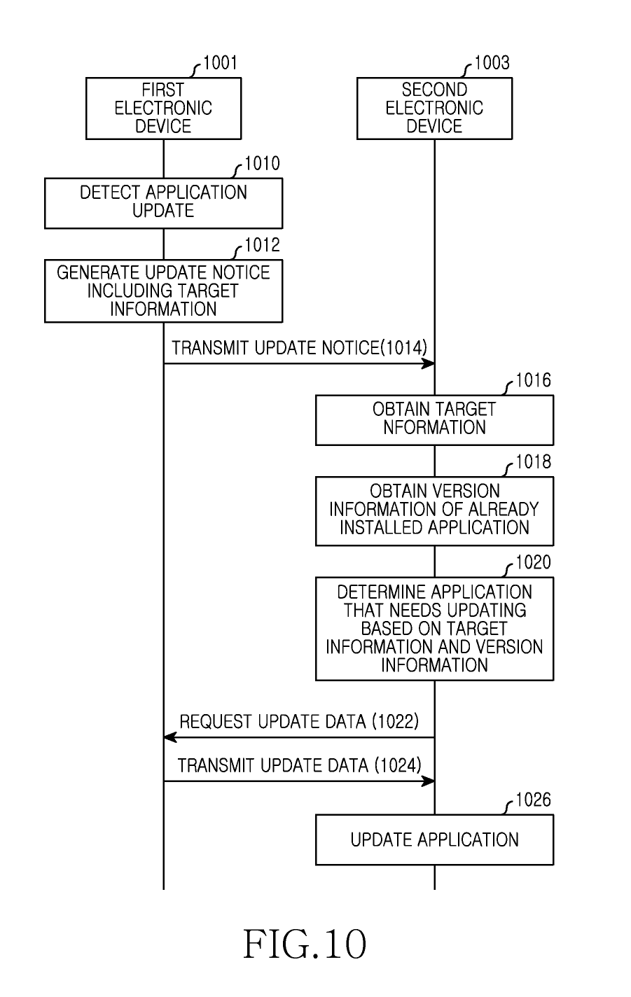

FIG. 10 is a flow diagram illustrating an application update operation according to an embodiment of the present invention.

According to an embodiment of the present invention, the first electronic device 1001 detects an update of at least one application among applications that are installed on by the first electronic device in step 1010. That is, an updated version of at least one application is available in the first electronic device.

The first electronic device 1001 determines target information for an update of the application, generates an update notice including the target information in step 1012, and transmits the same to the second electronic device 1003 in step 1014. The target information may be information of a version of an application before an update.

The second electronic device 1003 obtains the target information in the update notice received from the first electronic device 1001 in step 1016, and obtains version information of an already installed application in the second electronic device 1003 in step 1018.

The second electronic device 1003 determines an application that needs updating based on the target information and the version information in step 1020, and requests the first electronic device 1001 to transmit update data for the application that needs updating.

According to an embodiment of the present invention, the second electronic device 1003 may determine an update of an application having version information same as that of target information is necessary.

The first electronic device 1001 transmits the update data corresponding to a request of the second electronic device 1003 to the second electronic device 1003 in step 1024.

The second electronic device 1003 performs an update operation for an already installed application using the update data received from the first electronic device 1001 in step 1026.

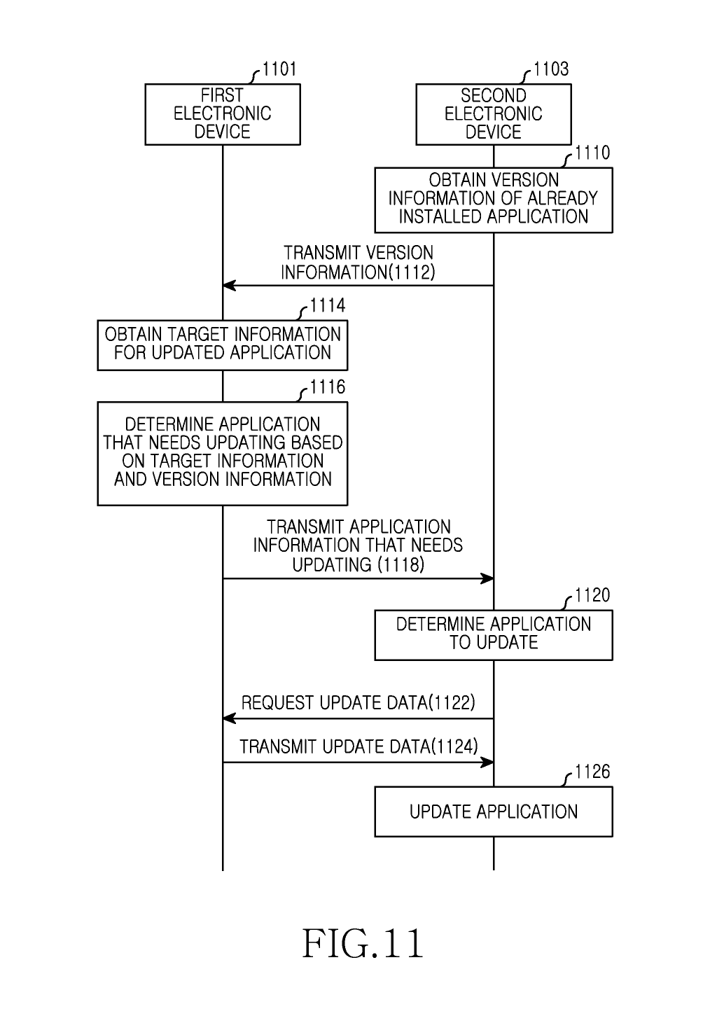

FIG. 11 is a flow diagram illustrating an application update operation according to an embodiment of the present invention.

According to an embodiment of the present invention, the second electronic device 1103 obtains version information of an already installed application in the second electronic device 1101 in step 1110, and transmits the same to the first electronic device 1101 in step 1112.

The first electronic device 1101 obtains target information for an update of an application among applications that are managed by the first electronic device 1101 in step 1114. Here, the target information may be information of a version of an application before an update.

The first electronic device 1101 determines an application that needs updating among applications installed in the second electronic device based on the target information and the received version information in step 1116, and transmits the determined information (information of an application that needs updating) to the second electronic device 1103 in step 1118.

The second electronic device 1103 determines an application to be updated using the determined information received from the first electronic device 1101 in step 1120, and then requests the first electronic device 1101 to transmit update data for the determined application in step 1122. According to an embodiment of the present invention, the first electronic device 1101 may transmit a list of applications that need updating, and the second electronic device may request update data for an application selected by a user among the applications in the received list.

The first electronic device 1101 transmits the update data corresponding to a request of the second electronic device 1103 to the second electronic device 1103 in step 1124.

The second electronic device 1103 performs an update operation for an already installed application using the update data received from the first electronic device 1101 in step 1126.

According to an embodiment of the present invention, a method for operating the first electronic device may include, when an update for an application provided to a second electronic device is detected, generating an update notice including target information for the application to be updated, transmitting the generated update notice to the second electronic device, and transmitting update data for the application to the second electronic device that has responded to the update notice.

According to an embodiment of the present invention, the target information may include version information of the application that needs an update operation.

According to an embodiment of the present invention, the method for operating the first electronic device may include receiving information for an already installed application in the second electronic device from the second electronic device; determining the application that needs an update operation among applications installed in the second electronic device based on the received information; and generating the update notice including information for the determined application.

According to an embodiment of the present invention, a method for operating a second electronic device may include receiving an update notice including target information representing an update object from a first electronic device; determining an application that needs an update operation among already installed applications in the second electronic device based on the target information of the received update notice; and receiving update data from the first electronic device so that the determined application is to be updated.

According to an embodiment of the present invention, determining the application that needs the update operation may include obtaining version information of the application; and comparing the target information of the received update notice with the obtained version information of the application.

According to an embodiment of the present invention, receiving the update data may include determining a list of applications that need updating; determining at least one application on which an update operation is to be performed among the determined list as the determined application; and requesting the update data for the determined application.

According to an embodiment of the present invention, the update notice may include information of at least one target that is the update object.

According to an embodiment of the present invention, the method for operating the second electronic device may include transmitting version information of an already installed application in the second electronic device to the first electronic device; and receiving information of an application determined by the first electronic device that needs updating from the first electronic device.

According to an embodiment of the present invention, the method for operating the first electronic device may be a method for operating an application server.

According to an embodiment of the present invention, the method for operating the second electronic device may be a method for operating a mobile communication terminal, for example, a smartphone.

Methods according to embodiments described in claims and/or specification of the present invention may be implemented in the form of hardware, software, or a combination of hardware and software.

In case of implementation using software, a computer-readable storage medium storing one or more programs (software modules) may be provided. One or more programs stored in the computer-readable storage medium are configured for execution by one or more processors in the electronic device. One or more programs include instructions allowing the electronic device to execute methods according to embodiments described in claims and/or specification of the present invention.

This program (a software module, software) may be stored in a random access memory, a non-volatile memory including a flash memory, Read Only Memory (ROM), an Electrically Erasable Programmable Read Only Memory (EEPROM), a magnetic disc storage device, a Compact Disc ROM (CD-ROM), Digital Versatile Discs (DVDs), or other types of optical storage devices, and a magnetic cassette. Alternatively, this program may be stored in a memory configured using all or a portion thereof Also, a plurality of respective constituent memories may be provided.

The program may be stored in an attachable storage device that may access the electronic device via a communication network such as the Internet, an Intranet, a Local Area Network (LAN), a Wide LAN (WLAN), or a Storage Area Network (SAN), or a communication network configured using a combination thereof This storage device may access the electronic device via an external port.

A separate storage device on a communication network may access a portable electronic device.

According to an embodiment of the present invention, a computer-readable recording medium may record a program thereon in a second electronic device, the program for executing an operation of receiving an update notice including target information representing an update object from a first electronic device, an operation of determining an application that needs an update operation among already installed applications in the second electronic device based on target information of the received update notice, and an operation of receiving update data from the first electronic device so that the determined application is to be updated.

According to an embodiment of the present invention, the computer-readable recording medium may record a program thereon in the second electronic device, the program for executing an operation of transmitting version information of an already installed application in the second electronic device to the first electronic device, and an operation of receiving information of an application determined by the first electronic device that needs updating from the first electronic device.

According to an embodiment of the present invention, only an electronic device in which an application corresponding to an update object has been installed may perform an update operation.

Although certain embodiments have been described in the detailed description of the present invention, an operation sequence of an electronic device may change or be merged or may be reused, and various modifications such as omission are possible without departing from the scope of the present invention. Therefore, the scope of the present invention should not be limited to the above-described embodiments but should be determined by not only the appended claims and the equivalents thereof

What is claimed is:

1. A method of operating a first electronic device, the method comprising:
when an update is detected with respect to an application provided to at least one second electronic device, generating an update notice including target information for the application to be updated;
transmitting the generated update notice to the at least one second electronic device; and
transmitting update data of the application to a second electronic device that has responded to the update notice,
wherein the target information includes version information of the application that needs an update operation.

2. The method of claim 1, further comprising:
receiving information for an already installed application in the second electronic device from the second electronic device;
determining the application that needs an update operation among applications installed in the second electronic device based on the received information; and
generating the update notice including information for the determined application.

3. A method of operating a second electronic device, the method comprising:
receiving an update notice including target information representing an update object from a first electronic device;
determining an application that needs an update operation among already installed applications in the second electronic device based on the target information of the received update notice; and
receiving update data from the first electronic device so that the determined application is updated.

4. The method of claim 3, wherein determining the application that needs the update operation comprises:
obtaining version information of the already installed application; and
comparing the target information of the received update notice with the obtained version information of the application.

5. The method of claim 3, wherein receiving the update data comprises:
determining a list of applications that need updating;
determining at least one application on which the update operation is to be performed among the determined list as the determined application; and
requesting the update data for the determined application.

6. The method of claim 3, wherein the update notice includes information of at least one target that is the update object.

7. The method of claim 3, further comprising:
transmitting version information of the already installed application in the second electronic device to the first electronic device; and
receiving information of an application determined by the first electronic device that needs updating from the first electronic device.

8. A first electronic device comprising:
an update determination module configured to, when an update is detected with respect to an application provided to at least one second electronic device, generate an update notice including target information for the application to be updated,
wherein the first electronic device is configured to transmit the generated update notice to the second electronic device, and to transmit update data of the application to a second electronic device that has responded to the update notice.

9. The first electronic device of claim 8, wherein the update determination module is further configured to receive information for an already installed application in the second electronic device from the second electronic device, to determine the application that needs an update operation among applications installed in the second electronic device based on the received information, and to generate the update notice including information for the determined application.

10. The first electronic device of claim 8, wherein the first electronic device comprises an application server.

11. A second electronic device comprising:
a data management module configured to manage update information of an already installed application in the second electronic device;
a communication module configured to receive an update notice including target information representing an update object from a first electronic device; and
an update determination module configured to determine update necessity of the already installed application based on the update information managed by the data management module and the target information received via the communication module.

12. The second electronic device of claim 11, wherein the data management module is further configured to manage at least one of a latest updated data for the already installed application, version information of a latest updated file for the already installed application, an update history for the already installed application as the update information.

13. The second electronic device of claim 11, wherein the communication module is further configured to request the first electronic device to transmit update data for the already installed application corresponding to the update information when it is determined, by the update determination module, that the update information corresponds to the target information.

14. The second electronic device of claim 11, wherein the second electronic device comprises a mobile communication terminal.

15. The second electronic device of claim 11, wherein the communication module is further configured to transmit the update information of the already installed application to the first electronic device, to receive information of an application determined by the first electronic device that needs updating from the first electronic device, and to request update data for the already installed application based on the received information.

16. A non-transitory computer-readable recording medium comprising a program recorded thereon in a second electronic device, the program executing operations of:
receiving an update notice including target information representing an update object from a first electronic device,
determining an application that needs an update operation among already installed applications in the second electronic device based on the target information of
the received update notice, and receiving update data from the first electronic device so that the determined application is updated.

17. The computer-readable recording medium of claim 16, further comprising:
transmitting version information of an already installed application in a second electronic device to the first electronic device, and
receiving information of an application determined by the first electronic device that needs updating from the first electronic device.
